(19) United States
(12) Patent Application Publication
(10) Pub. No.: US 2026/0237864 A1
(43) Pub. Date: Aug. 13, 2026

(54) SECONDARY BATTERY

(71) Applicant: SAMSUNG SDI CO., LTD., Yongin-si (KR)

(72) Inventors: Subong HONG, Yongin-si (KR); Chonghoon LEE, Yongin-si (KR); Sanghyuck AHN, Yongin-si (KR); Wanuk CHOI, Yongin-si (KR)

(21) Appl. No.: 19/408,565

(22) Filed: Dec. 4, 2025

(30) Foreign Application Priority Data
Feb. 11, 2025 (KR) 10-2025-0017321

(51) Int. Cl. H01M 50/533; H01M 10/052; H01M 10/0583; H01M 10/0585; H01M 50/103; H01M 50/119; H01M 50/15; H01M 50/159

(52) U.S. Cl. CPC H01M 50/533; H01M 10/052; H01M 10/0583; H01M 10/0585; H01M 50/103; H01M 50/119; H01M 50/15; H01M 50/159

(57) ABSTRACT

A secondary battery includes a body comprising an accommodation part having an accommodation space, an electrode assembly is accommodated in the accommodation space. The electrode assembly comprises a first electrode, a second electrode, and a first separator disposed between the first electrode and the second electrode. A cover is disposed on the body, and a first electrode composite layer disposed between the electrode assembly and the cover.

### CROSS-REFERENCE TO RELATED APPLICATION

The present application claims priority to and the benefit of Korean Application No. 10-2025-0017321, filed on Feb. 11, 2025, in the Korean Intellectual Property Office, the entire disclosure of which is incorporated by reference herein.

### BACKGROUND

### Field

The present disclosure relates to secondary batteries.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders. Large-capacity secondary batteries are widely used as power sources for driving motors in hybrid vehicles and electric vehicles and for storing power (e.g., home and/or utility scale power storage). A secondary battery generally includes an electrode assembly comprising a positive electrode and a negative electrode, a case accommodating the electrode assembly, and electrode terminals connected to the electrode assembly.

Since a secondary battery having a high energy density (energy density being an amount of energy that can be stored per unit volume) may provide a longer run time in a portable device or a longer driving range in an electric vehicle, the energy density of the secondary battery is one of the important factors that determine the performance of the secondary battery. Accordingly, various techniques have been proposed to increase the energy density by improving the structure of the secondary battery.

The information disclosed in this section is for enhancement of understanding of the background of the present disclosure. It may contain information that does not constitute related or prior art.

### SUMMARY

The present disclosure provides a secondary battery configured to address the above-described problems. These and other aspects and features of the present disclosure will be described in or will be apparent from the following description of embodiments of the present disclosure.

According to some embodiments of the present disclosure, a secondary battery includes a body comprising an accommodation part having an accommodation space, an electrode assembly accommodated in the body, with the electrode assembly including a first electrode, a second electrode, and a first separator disposed between the first electrode and the second electrode, a cover disposed on the body, and a first electrode composite layer disposed between the electrode assembly and the cover.

According to some embodiments of the present disclosure, the first electrode composite layer may be attached to a lower surface of the cover.

According to some embodiments of the present disclosure, the secondary battery may further include a second separator disposed between the first electrode composite layer and the electrode assembly.

According to some embodiments of the present disclosure, the first electrode composite layer may contact the second separator.

According to some embodiments of the present disclosure, the second separator may be formed integrally with the electrode assembly.

According to some embodiments of the present disclosure, the first electrode composite layer may be a negative electrode composite layer.

According to some embodiments of the present disclosure, the first electrode composite layer may be formed of a dry electrode composite film.

According to some embodiments of the present disclosure, the secondary battery may further include a second electrode composite layer disposed between a bottom portion of the body and the electrode assembly, the second electrode composite layer having the same polarity as the first electrode composite layer.

According to some embodiments of the present disclosure, the second electrode composite layer may be attached to the bottom portion of the body.

According to some embodiments of the present disclosure, the secondary battery may further include a third separator disposed between the second electrode composite layer and the electrode assembly.

According to some embodiments of the present disclosure, the second electrode composite layer may contact the third separator.

According to some embodiments of the present disclosure, the third separator may be formed integrally with the electrode assembly.

According to some embodiments of the present disclosure, the second electrode composite layer may be formed of a dry electrode composite film.

According to some embodiments of the present disclosure, the first electrode may include a first substrate and a third electrode composite layer disposed on the first substrate and having the same polarity as the first electrode composite layer, and the second electrode may include a second substrate and a fourth electrode composite layer disposed on the second substrate and having a polarity different from that of the first electrode composite layer.

According to some embodiments of the present disclosure, the body may further include a flange portion surrounding an open side of the body.

According to some embodiments of the present disclosure, the flange portion and the cover may be joined to seal the accommodation part.

According to some embodiments of the present disclosure, the body and the cover may be formed of the same metallic material.

According to some embodiments of the present disclosure, the metallic material may include stainless steel.

According to some embodiments of the present disclosure, a secondary battery includes a body comprising an accommodation part having an accommodation space, an electrode assembly accommodated in the accommodation space, the electrode assembly comprising a first electrode, a second electrode, and a first separator disposed between the first electrode and the second electrode, a cover disposed on the body, a first electrode composite layer attached to a lower surface of the cover, a second electrode composite layer attached to a bottom portion of the body, a second separator disposed between the first electrode composite layer and the electrode assembly, and a third separator disposed between the second electrode composite layer and the electrode assembly.

According to some embodiments of the present disclosure, the first electrode composite layer and the second electrode composite layer may each be formed of a dry electrode composite film.

According to embodiments of the present disclosure, an electrode composite layer that is attached to the case of the secondary battery may function as a current collector. Accordingly, a current collector situated at the outermost portion of the electrode assembly is replaced by the electrode composite layer. As a result, the energy density of the secondary battery may be increased.

However, aspects and features of the present disclosure are not limited to those described above, and other aspects and features not mentioned will be clearly understood by a person skilled in the art from the detailed description, described below.

### BRIEF DESCRIPTION OF DRAWINGS

The drawings illustrate embodiments of the present disclosure and further describe aspects and features of the present disclosure together with the detailed description of the present disclosure. The present disclosure is not limited to embodiments depicted in the drawings.

FIG. 1 is an exploded perspective view of a secondary battery according to some embodiments of the present disclosure.

FIG. 2 is a front view of a secondary battery according to some embodiments of the present disclosure as viewed from the front.

FIG. 3 is a plan view of the secondary battery of FIG. 2 as viewed in a V_1 direction.

FIG. 4 is a side view of the secondary battery of FIG. 2 as viewed in a V_2 direction.

FIG. 5 is a rear view of the secondary battery of FIG. 2 as viewed from the rear.

FIG. 6 is a cross-sectional view of a case of a secondary battery according to some embodiments of the present disclosure.

FIG. 7 is a cross-sectional view of a secondary battery according to some embodiments of the present disclosure.

FIGS. 8 and 9 illustrate a method of manufacturing a dry electrode according to some embodiments of the present disclosure.

FIG. 10 is a flow chart of a method of manufacturing a secondary battery according to some embodiments of the present disclosure.

FIGS. 11 and 12 illustrate a method of manufacturing a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

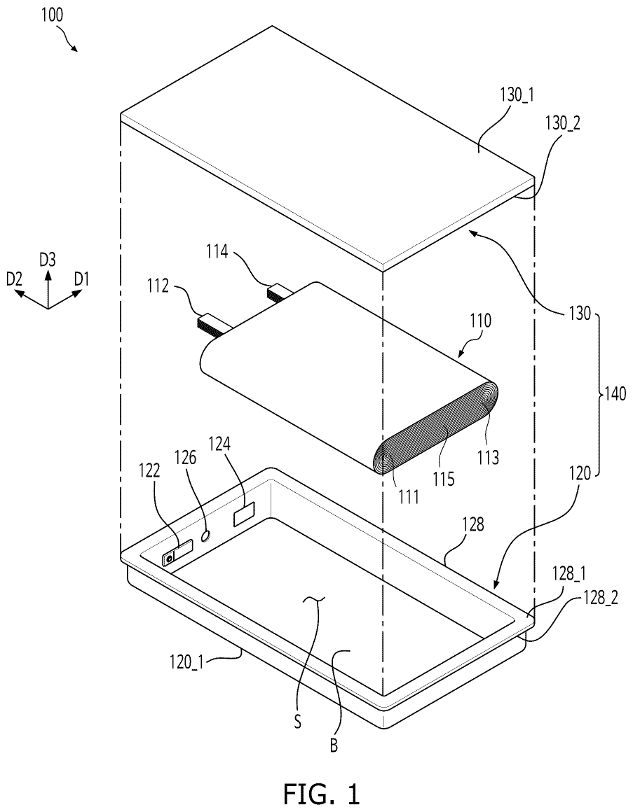

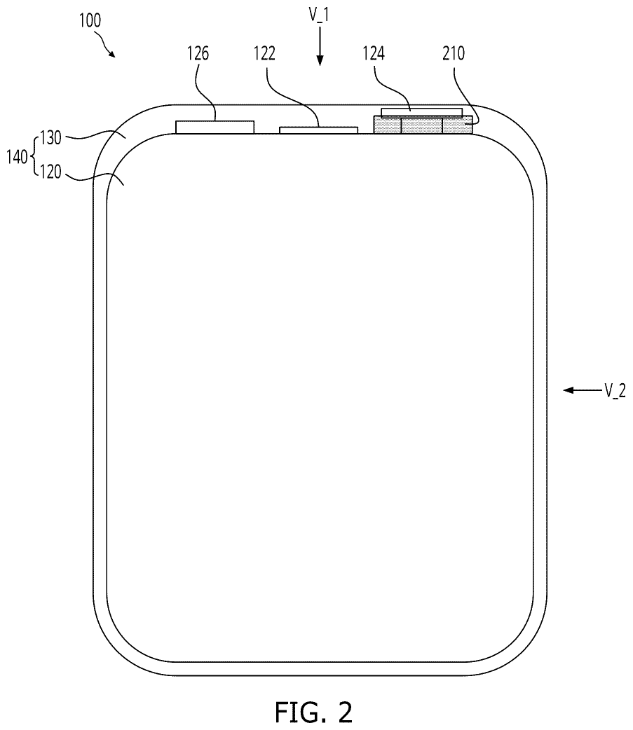

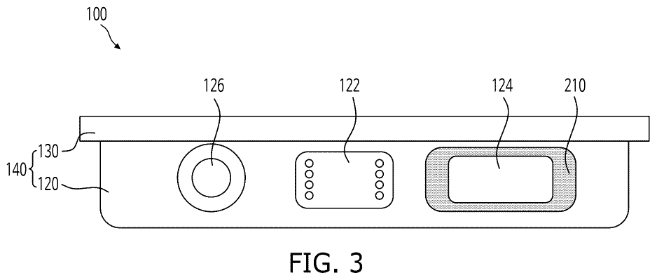

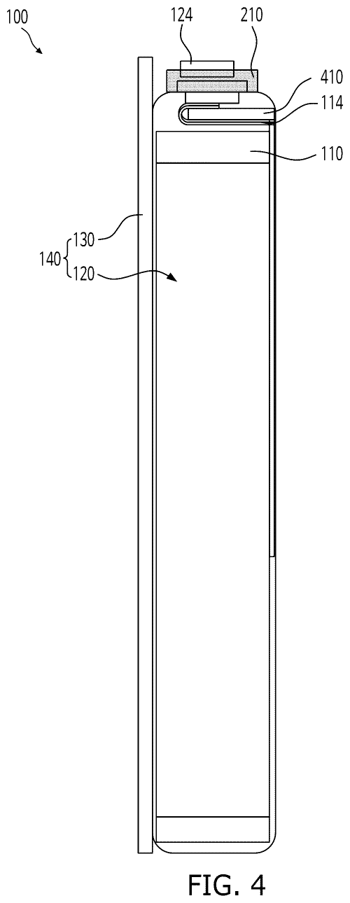

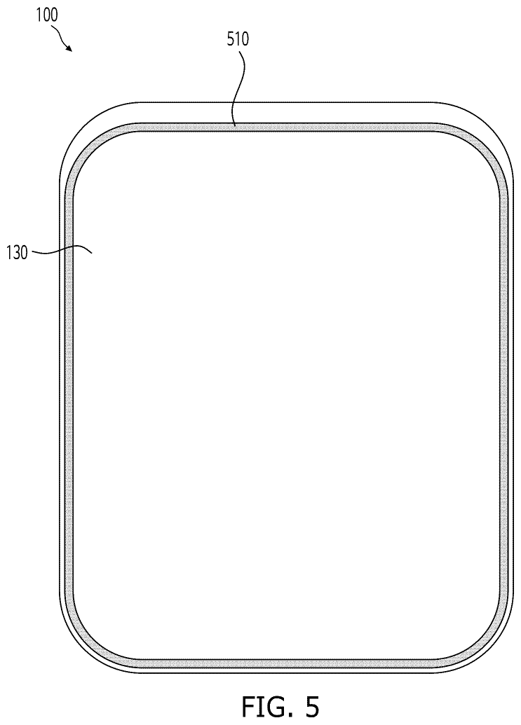

FIG. 1 is an exploded perspective view of a secondary battery 100 according to some embodiments of the present disclosure. FIG. 2 is a front view of the secondary battery 100 according to some embodiments of the present disclosure as viewed from the front. FIG. 3 is a plan view of the secondary battery 100 of FIG. 2 as viewed in a V_1 direction. FIG. 4 is a side view of the secondary battery 100 of FIG. 2 as viewed in a V_2 direction. FIG. 5 is a rear view of the secondary battery 100 of FIG. 2 as viewed from the rear. In this context, the front of the secondary battery 100 refers to a front portion 120_1 of a body 120 of the secondary battery 100, which will be described below. The rear of the secondary battery 100 refers to a portion opposite to the front of the secondary battery 100 or refers to an upper surface 130_1 of a cover 130, which will be described below.

Referring to FIGS. 1-5, the secondary battery 100 may include an electrode assembly 110. The electrode assembly 110 includes a first electrode 111, a second electrode 113, and a separator 115 disposed between the first electrode 111 and the second electrode 113. The electrode assembly 110 may be wound or stacked with the separator 115, which is an insulator, interposed between the first electrode 111 and the second electrode 113. In such a configuration, the first electrode 111 may correspond to a positive electrode and the second electrode 113 may correspond to a negative electrode. The secondary battery 100 illustrated in FIG. 1 may be a pouch-type secondary battery. However, the secondary battery according to the present disclosure is not limited thereto and may be various types of secondary batteries such as prismatic or cylindrical types.

The positive electrode and the negative electrode may each include a coated portion, which is a region in which an active material is coated on a current collector formed of a thin metal foil. The positive and negative electrodes also each include an uncoated portion where the active material is not provided. After the separator, which is an insulator, is interposed between the positive electrode and the negative electrode, the positive electrode and the negative electrode may be wound with the separator. However, the present disclosure is not limited to such an arrangement. For example, in other embodiments, the electrode assembly may have a structure in which a plurality of positive-electrode sheets and negative-electrode sheets are alternately stacked with a separator interposed therebetween.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material). The positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles to each other and also to attach the positive electrode active material to the current collector. Examples of the binder include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like. But the present disclosure is not limited to these examples.

The conductive material may be used to provide conductivity (e.g., electrical conductivity) to the electrode. Any material that does not cause an undesirable chemical change in a battery (and conducts electrons can be used as the conductive material.

Examples of the conductive material include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a composite thereof.

Aluminum may be used as the current collector. But the present disclosure is not limited thereto.

A separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The negative electrode for a rechargeable lithium battery may include a current collector and a negative electrode active material layer on the current collector. The negative electrode active material layer may include a negative electrode active material, and the negative active material layer may further include a binder and/or a conductive material (e.g., an electrically conductive material).

The negative electrode active material layer may include, for example, about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles to each other and also to attach the negative electrode active material to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause an undesirable chemical change in a rechargeable lithium battery and that conducts electrons can be used in the battery. Non-limiting examples of the conductive material include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a composite thereof.

The negative current collector may include a copper foil, a nickel foil, a stainless steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or composite of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof. But the present disclosure is not limited to these examples.

The organic material and the inorganic material may be mixed in one coating layer. In other embodiments, a coating layer including an organic material and a coating layer including an inorganic material may be stacked.

The secondary battery 100 may further include a first electrode tab 112 connected to the first electrode 111 and a second electrode tab 114 connected to the second electrode 113. The first electrode tab 112 and the second electrode tab 114 may be connected to uncoated portions of the first electrode 111 and the second electrode 113, respectively, by welding. In other embodiments, the electrode tabs 112 and 114 may be formed by punching the uncoated portions of the first electrode 111 and the second electrode 113. In the wound state, the first electrode tab 112 and the second electrode tab 114 may be disposed in parallel at predetermined intervals. Alternatively, the electrode assembly 110 may have any structure including electrode tabs.

The secondary battery 100 may include a body 120 including an accommodation part S having an accommodation space configured to receive the electrode assembly 110, and a cover 130 disposed on the body 120. The body 120 may further include a flange portion 128 surrounding an open side of the body 120. The flange portion 128 and the cover 130 may be joined to seal the accommodation part S. The body 120 and the cover 130 may constitute a case 140 of the secondary battery 100.

The case 140 forms the overall exterior of the secondary battery 100 and may be formed of a conductive metal such as aluminum, an aluminum alloy, or nickel-plated steel. The case 140 may include a metallic material such as stainless steel (SUS) or aluminum (Al). However, the present disclosure is not limited thereto, and the case 140 may be formed of various metallic materials that provide the strength required by the secondary battery 100 and resistance to external impact.

The case 140 may include the body 120 configured to receive the electrode assembly 110. The body 120 may include the accommodation part S having one end opened in a direction perpendicular (for example, in a D3 direction) to a front 120_1 of the body 120. The body 120 may further include the flange portion 128 extending from the open end in a direction parallel (for example, in a D1 or D2 direction) to the front 120_1 of the body 120. The accommodation part S of the body 120 may be formed by press working or the like to include an accommodation space in which the electrode assembly 110 is received.

A planar shape of the accommodation part S of the case 140 may be formed, for example, as a substantially quadrangular shape. The case 140 may further include the cover 130 welded to the flange portion 128 to seal the open end of the accommodation part S. The cover 130 may be formed as a flat plate disposed on an upper portion of the case 140 to seal the accommodation part S. For example, the cover 130 may be formed as a flat plate having a size sufficient to cover the flange portion 128, with the cover 130 contacting the flange portion 128. That is, a lower surface 130_2 of the cover 130 and an upper surface 128_1 of the flange portion 128 may be in contact with each other. The body 120 and the cover 130 may be formed of the same metallic material, such as stainless steel.

By joining the flange portion 128 and the cover 130, the accommodation part S may be sealed, and the body 120 and the cover 130 may form a single combined structure as the case 140. The body 120 may be joined to the cover 130 by welding. However, in the present disclosure, the joining method is not limited to welding, and various joining methods capable of sealing the accommodation part S may be employed. For example, the cover 130 and the flange portion 128 may be joined by laser welding as well as ultrasonic welding, brazing, laser brazing, welding, soldering, and the like. As the cover 130 is welded, a weld bead 510 may be formed on the cover 130 of the secondary battery 100. For example, the weld bead 510 may be formed on the upper surface 130_1 of the cover 130 of the secondary battery 100.

The body 120 of the secondary battery 100 may further include a first electrode terminal 122 and a second electrode terminal 124. The first electrode terminal 122 may be electrically connected to the first electrode tab 112 of the electrode assembly 110 and a second electrode terminal 124 may be electrically connected to the second electrode tab 114 of the electrode assembly 110, with the first and second electrode terminals 122 and 124 being coupled to the body 120. The first and second electrode terminals 122 and 124 may be disposed on at least one side surface of the case 140, specifically, on at least one side surface of the body 120. The first electrode terminal 122 and the second electrode terminal 124 may be disposed on one side surface of the body 120 so as to face a direction (for example, the D2 direction) parallel to the front 120_1 of the body 120. But the positions of the first and second electrode terminals 122 and 124 according to the present disclosure are not limited to the positions illustrated in FIG. 1 and may have various other positions in other embodiments of the present disclosure.

The first electrode terminal 122 may be a negative electrode terminal, and the second electrode terminal 124 may be a positive-electrode terminal. When the second electrode terminal 124 is the positive-electrode terminal, an insulator 210 configured to partially surround the second electrode terminal 124 may be further provided. The insulator 210 may prevent the second electrode terminal 124 from contacting the body 120. That is, the insulator 210 may prevent a short circuit of the second electrode terminal 124 with the body 120.

The first electrode tab 112 may be bent to be electrically connected to the first electrode terminal 122. The second electrode tab 114 may be bent to be electrically connected to the second electrode terminal 124. An insulating plate 410 may be further disposed between bent portions of the second electrode tab 114. The insulating plate 410 may prevent contact between the bent portions of the second electrode tab 114. That is, the insulating plate 410 may prevent a short circuit caused by the bent portions of the second electrode tab 114. For example, when the secondary battery 100 is deformed due to external impact or the like, the insulating plate 410 may prevent a short circuit resulting from deformation of the bent portions of the second electrode tab 114. The insulator 210 and the insulating plate 410 may be formed of various materials that are capable of blocking electrical connection, such as polypropylene or polyethylene.

The secondary battery 100 may further include an electrolyte injection port 126. For example, the electrolyte injection port 126 may be a through hole formed in at least one side surface of the case 140. For example, the electrolyte injection port 126 may be a through-hole formed in at least one side surface of the body 120. The electrolyte injection port 126 may be formed at in line with the first electrode terminal 122 and the second electrode terminal 124. The electrolyte injection port 126 may be formed to allow the injection of electrolyte into an interior of the case 140 after the body 120 and the cover 130 are joined to form the case 140. After the electrolyte is injected, the electrolyte injection port 126 may be sealed with a sealing member.

The secondary battery 100 may be a lithium battery cell, a sodium battery cell, and the like. However, the scope of the present disclosure is not limited thereto, and the secondary battery 100 can be any type of battery that is capable of repeatedly supplying electric power through charging and discharging. In an embodiment where the secondary battery 100 is a lithium battery cell, superior life characteristics and high-rate characteristics may allow it to be used in an electric vehicle (EV). For example, the secondary battery 100 may be used in a plug-in hybrid electric vehicle (PHEV) or another hybrid vehicle. In addition, the lithium battery cell may be used in fields that require storage of power over various ranges, for example, in a smart phone, a tablet PC, an electric bicycle, a power tool, and the like. But the present disclosure is not limited to these examples.

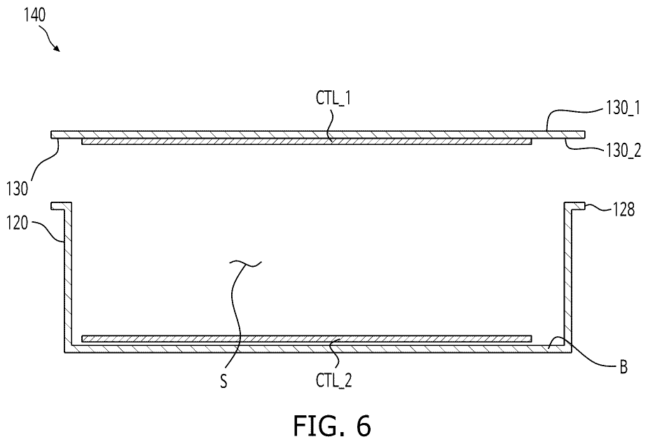

FIG. 6 is a schematic cross-sectional view of the case 140 of a secondary battery according to some embodiments of the present disclosure.

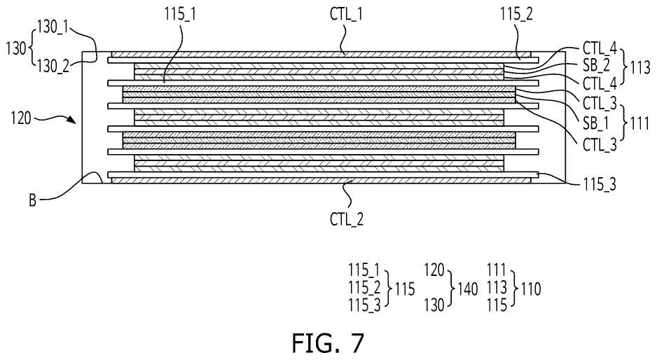

Referring to FIG. 6, the case 140 may include the body 120 and the cover 130. An accommodation space may be formed in the accommodation part S of the body 120 so that the electrode assembly (for example, the electrode assembly 110 of FIG. 1) can be accommodated in the accommodation part S. The case 140 together with the electrode assembly may constitute the secondary battery (for example, the secondary battery 100 of FIG. 1). A detailed configuration thereof will be described below with reference to FIG. 7.

When the electrode assembly (for example, the electrode assembly 110 of FIG. 1) is accommodated in the accommodation part S, the secondary battery (for example, the secondary battery 100 of FIG. 1) may include a first electrode composite layer CTL_1 disposed between the electrode assembly and the cover 130. The first electrode composite layer CTL_1 may be attached to the lower surface 130_2 of the cover 130. The first electrode composite layer CTL_1 may be a negative electrode composite layer. The first electrode composite layer CTL_1 may be formed of a dry-electrode composite film. Accordingly, the first electrode composite layer CTL_1 can be easily attached to the lower surface 130_2 of the cover 130. The first electrode composite layer CTL_1 may contact the electrode assembly received in the accommodation part S. With such a configuration, the case 140 may function as a current collector of the secondary battery.

When the electrode assembly is accommodated in the accommodation part S, the secondary battery may further include a second electrode composite layer CTL_2 disposed between a bottom portion B of the body 120 and the electrode assembly. The second electrode composite layer CTL_2 may have the same polarity as the first electrode composite layer CTL_1. That is, when the first electrode composite layer CTL_1 is a negative electrode composite layer, the second electrode composite layer CTL_2 may also be a negative-electrode composite layer. The second electrode composite layer CTL_2 may be attached to an upper surface of the bottom portion B of the body 120. The second electrode composite layer CTL_2 may be formed of a dry-electrode composite film. Accordingly, the second electrode composite layer CTL_2 can be easily attached to the upper surface of the bottom portion B of the body 120. The second electrode composite layer CTL_2 may contact the electrode assembly received in the accommodation part S. With such a configuration, the case 140 may function as a current collector of the secondary battery.

The case 140 may include at least one of the first electrode composite layer CTL_1 and the second electrode composite layer CTL_2. For example, the case 140 may include only the first electrode composite layer CTL_1. The case 140 may include only the second electrode composite layer CTL_2. The case 140 may include both the first electrode composite layer CTL_1 and the second electrode composite layer CTL_2.

FIG. 7 is a schematic cross-sectional view of a secondary battery 100 according to some embodiments of the present disclosure. Detailed descriptions of configurations disclosed in FIGS. 1-6 that are the same or similar to those disclosed in FIG. 7 will be omitted.

Referring to FIG. 7, the secondary battery 100 may include an electrode assembly 110 comprising a first electrode 111, a second electrode 113, and a first separator 155_1 disposed between the first electrode 111 and the second electrode 113. The first electrode 111, the second electrode 113, and the first separator 155_1 may have the same or similar configurations as the first electrode 111, the second electrode 113, and the separator 115 described above with respect to FIG. 1. Here, the first electrode 111 may be a negative electrode, and the second electrode 113 may be a positive electrode. However, the arrangement and/or polarity of the first electrode 111 and the second electrode 113 are not limited thereto and may be varied according to a structure of the secondary battery 100.

The secondary battery 100 may further include a body 120 including an accommodation part S having an accommodation space configured to receive the electrode assembly 110, a cover 130 disposed on the body 120, and a first electrode composite layer CTL_1 disposed between the electrode assembly 110 and the cover 130. The first electrode composite layer CTL_1 may be attached to the lower surface 130_2 of the cover 130. In addition, the secondary battery 100 may further include a second electrode composite layer CTL_2 disposed between a bottom portion B of the body 120 and the electrode assembly 110, the second electrode composite layer CTL_2 having the same polarity as the first electrode composite layer CTL_1. For example, the first electrode composite layer CTL_1 and the second electrode composite layer CTL_2 may be negative-electrode composite layers. The second electrode composite layer CTL_2 may be attached to the bottom portion B of the body 120. The first electrode composite layer CTL_1 and the second electrode composite layer CTL_2 may be formed of dry electrode composite films. Because the first electrode composite layer CTL_1 and the second electrode composite layer CTL_2 are formed of dry electrode composite films, the first electrode composite layer CTL_1 and the second electrode composite layer CTL_2 can be easily attached to the cover 130 and the bottom portion B of the body 120, respectively.

In other embodiments, the case 140 may include at least one of the first electrode composite layer CTL_1 and the second electrode composite layer CTL_2. For example, the case 140 may include only the first electrode composite layer CTL_1. The case 140 may include only the second electrode composite layer CTL_2. or the case 140 may include both the first electrode composite layer CTL_1 and the second electrode composite layer CTL_2.

The first electrode 111 may include a first substrate SB_1 and a third electrode composite layer CTL_3 disposed on the first substrate SB_1 and having the same polarity as the first electrode composite layer CTL_1. For example, in one embodiment the first electrode composite layer CTL_1 and the third electrode composite layer CTL_3 may both be negative-electrode composite layers. An in such a configuration, the first electrode 111 is a negative electrode. The third electrode composite layer CTL_3 may be disposed on one or both surfaces of the first substrate SB_1.

The second electrode 113 may include a second substrate SB_2 and a fourth electrode composite layer CTL_4 disposed on the second substrate SB_2 and having a polarity different from that of the first electrode composite layer CTL_1. For example, when the first electrode composite layer CTL_1 is a negative electrode composite layer, and the fourth electrode composite layer CTL_4 is a positive electrode composite layer. Accordingly, the second electrode 113 may be a positive electrode. The fourth electrode composite layer CTL_4 may be disposed on one surface or both surfaces of the second substrate SB_2. The third electrode composite layer CTL_3 and the fourth electrode composite layer CTL_4 may be formed of dry electrode composite films.

The secondary battery 100 may further include a second separator 115_2 disposed between the first electrode composite layer CTL_1 and the electrode assembly 110. In such an arrangement, the first electrode composite layer CTL_1 may contact the second separator 115_2. The second separator 115_2 may be formed integrally with the electrode assembly 110. For example, the first separator 155_1 and the second separator 115_2 may be formed by winding or folding the separator 115 (as described above with reference to FIG. 1). Thus, the separator 115 may constitute a part of the electrode assembly 110. Because the first electrode composite layer CTL_1 contacts the second separator 115_2, the case 140 of the secondary battery 100 can function as a current collector. For example, when the first electrode 111 is a negative electrode, the first electrode composite layer CTL_1 may be a negative electrode composite layer. When the first electrode composite layer CTL_1 contacts the second separator 115_2, the case 140 of the secondary battery 100 can function as a negative current collector. Thus, a space inside the case 140 in which a current collector would otherwise be accommodated can be replaced with an additional electrode composite layer. Accordingly, the energy density of the secondary battery 100 can be improved.

The secondary battery 100 may further include a third separator 115_3 disposed between the second electrode composite layer CTL_2 and the electrode assembly 110. Here, the second electrode composite layer CTL_2 may contact the third separator 115_3. The third separator 115_3 may be formed integrally with the electrode assembly 110. For example, the first separator 155_1 and the third separator 115_3 may be formed by winding or folding the separator 115 (as described above with reference to FIG. 1) and thus may constitute a part of the electrode assembly 110. Because the second electrode composite layer CTL_2 contacts the third separator 115_3, the case 140 of the secondary battery 100 can function as a current collector. For example, when the first electrode 111 is a negative electrode, the second electrode composite layer CTL_2 may be a negative electrode composite layer. When the second electrode composite layer CTL_2 contacts the third separator 115_3, the case 140 of the secondary battery 100 can function as a negative current collector. That is, a space inside the case 140 in which a current collector would otherwise be accommodated can be replaced with an additional electrode composite layer. Accordingly, the energy density of the secondary battery 100 can be improved.

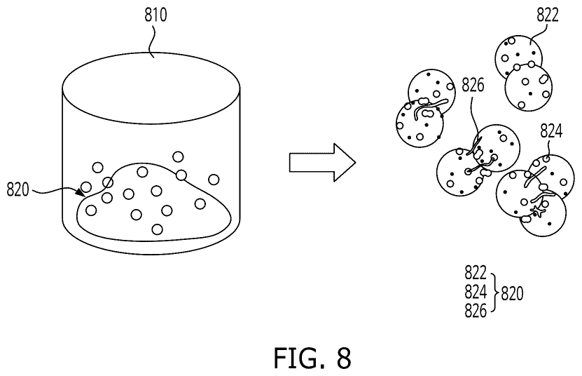

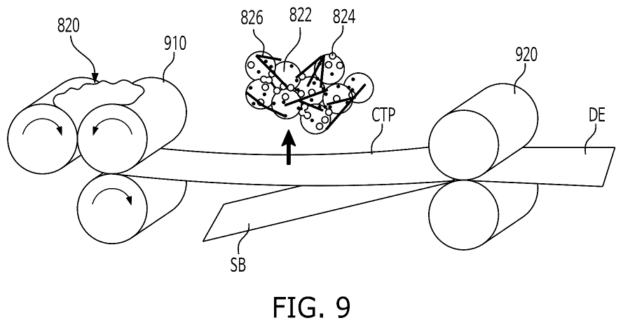

FIGS. 8 and 9 illustrate a method of manufacturing a dry electrode according to embodiments of the present disclosure. The first electrode 111 and the second electrode 113 disclosed above in conjunction with FIGS. 1-7 may be manufactured as dry electrodes according to the manufacturing method described below.

Referring to FIGS. 8 and 9, a composite 820 for a dry electrode film including an active material 822, a conductive material 824, and a binder 826 may be placed into a blender 810 and mixed. The active material 822 and the conductive material 824 may be the same materials as the active material and the conductive material disclosed above in conjunction with FIG. 1. The binder 826 may be the dry binder disclosed above in conjunction with FIG. 1. Although not illustrated in the present disclosure, a kneading step may be performed on the composite 820 for a dry electrode film. Through the kneading the binder 826 may be fibrillated. Thereafter, the composite 820 for a dry electrode film may be pulverized by a pulverizing apparatus 910 to generate a dry electrode composite film CTP. Although the pulverizing apparatus 910 is illustrated as a roll press in the present disclosure, the dry-electrode composite film CTP may be generated by various other means. The dry electrode composite film CTP may include, for example, the first electrode composite layer CTL_1, the second electrode composite layer CTL_2, the third electrode composite layer CTL_3, and the fourth electrode composite layer CTL_4 as disclosed above in conjunction with FIGS. 1-7. The generated dry electrode composite film CTP may be calendared on one or both surfaces of a substrate SB by a calendar apparatus 920 to produce a dry electrode DE. Although the calendar apparatus 920 is illustrated as a roll press in the present disclosure, the dry electrode DE may be produced by calendaring with various other means. Here, the substrate SB may constitute the first substrate SB_1 and/or the second substrate SB_2 as depicted in FIG. 7. The dry electrode DE may constitute the first electrode 111 and/or the second electrode 113 disclosed above in conjunction with FIGS. 1-7.

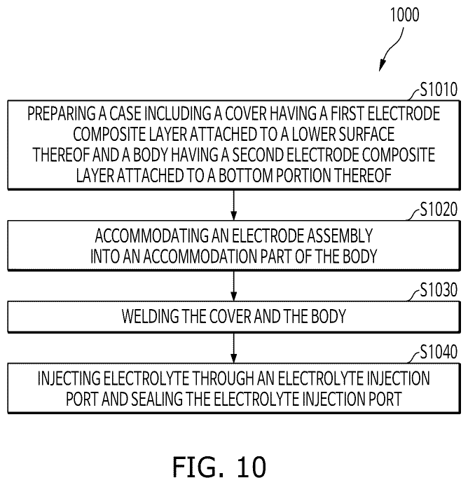

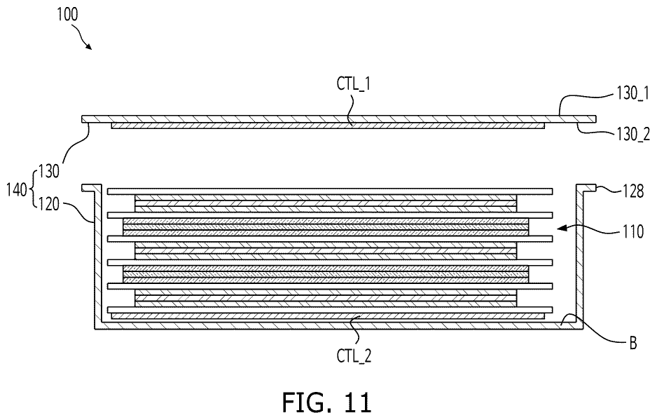

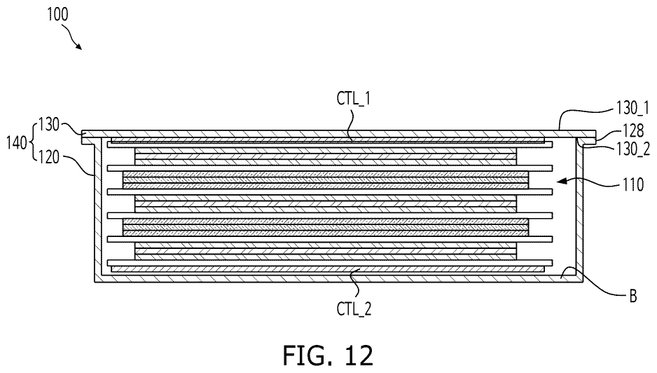

FIG. 10 is a flow chart 1000 of a method of manufacturing a secondary battery according to embodiments of the present disclosure. FIGS. 11 and 12 are schematic diagrams illustrating a method of manufacturing a secondary battery 100 according to embodiments of the present disclosure.

Referring to FIGS. 10-12, the method may begin by performing a step S1010 of preparing a case 140 including a cover 130 having the first electrode composite layer CTL_1 attached to a lower surface 130_2 thereof and a body 120 having the second electrode composite layer CTL_2 attached to a bottom portion B thereof. Detailed descriptions of the case 140 and the first and second electrode composite layers CTL_1 and CTL_2 have been provided above.

Next, a step S1020 of accommodating the electrode assembly 110 in the accommodation part (for example, the accommodation part S of FIG. 1) of the body 120 may be performed. The accommodation part may have a predetermined accommodation space to receive the electrode assembly 110. The electrode assembly 110 may contact the first electrode composite layer CTL_1 and the second electrode composite layer CTL_2.

Next, a step S1030 of welding the cover 130 and the body 120 may be performed. For example, the cover 130 may be joined to the flange portion 128 surrounding the open side of the body 120. Accordingly, a weld bead (for example, the weld bead 510 depicted in FIG. 5) may be formed on the cover 130. Specifically, the weld bead may be formed on the upper surface 130_1 of the cover 130. Although the cover 130 and the body 120 are joined by welding in the present disclosure, the cover 130 and the body 120 may be joined by various methods and the present disclosure is not limited in this regard. By joining the cover 130 and the body 120, the case 140 may be formed and the accommodation part (for example, the accommodation part S of FIG. 1) may be sealed.

Finally, a step S1040 of injecting electrolyte through the electrolyte injection port and sealing the electrolyte injection port may be performed. The electrolyte injection port may have the same or similar configuration as the electrolyte injection port 126 disclosed above in conjunction with FIGS. 1-3. Through the steps described above, the secondary battery 100 according to some embodiments of the present disclosure may be manufactured. Because the case 140 of the secondary battery 100 functions as a current collector in the secondary battery 100 manufactured according to the method described above, a current collector disposed in the electrode assembly 110 can be replaced with an electrode composite layer. Accordingly, the energy density of the secondary battery 100 can be increased.

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

100: secondary battery
110: electrode assembly
111: first electrode
112: first electrode tab
113: second electrode
114: second electrode tab
115: separator
120: body
120_1: front of body
122: first electrode terminal
124: second electrode terminal
126: electrolyte injection port
128: flange portion
128_1: upper surface of flange portion
128_2: lower surface of flange portion
130: cover
130_1: upper surface of cover
130_2: lower surface of cover
140: case
S: accommodation part
B: bottom portion

What is claimed is:

1. A secondary battery comprising:
a body comprising an accommodation part having an accommodation space;
an electrode assembly accommodated in the accommodation space, the electrode assembly comprising a first electrode, a second electrode, and a separator disposed between the first electrode and the second electrode; and
a cover disposed on the body; and
an electrode composite layer disposed between the electrode assembly and the cover.

2. The secondary battery according to claim 1, wherein the electrode composite layer is attached to a lower surface of the cover.

3. The secondary battery according to claim 1, wherein the separator is a first separator, and
wherein the secondary battery further comprises a second separator disposed between the electrode composite layer and the electrode assembly.

4. The secondary battery according to claim 3, wherein the electrode composite layer contacts the second separator.

5. The secondary battery according to claim 3, wherein the second separator is formed integrally with the electrode assembly.

6. The secondary battery according to claim 1, wherein the electrode composite layer is a negative electrode composite layer.

7. The secondary battery according to claim 1, wherein the electrode composite layer comprises a dry electrode composite film.

8. The secondary battery according to claim 1, wherein the electrode composite layer is a first electrode composite layer, and
wherein the secondary battery further comprises a second electrode composite layer disposed between a bottom portion of the body and the electrode assembly, the second electrode composite layer having a same polarity as the first electrode composite layer.

9. The secondary battery according to claim 8, wherein the second electrode composite layer is attached to the bottom portion of the body.

10. The secondary battery according to claim 8, wherein the separator is a first separator, and
wherein the secondary battery further comprises a second separator disposed between the second electrode composite layer and the electrode assembly.

11. The secondary battery according to claim 10, wherein the second electrode composite layer contacts the second separator.

12. The secondary battery according to claim 10, wherein the second separator is formed integrally with the electrode assembly.

13. The secondary battery according to claim 8, wherein the second electrode composite layer comprises a dry electrode composite film.

14. The secondary battery according to claim 1, wherein the electrode composite layer is a first electrode composite layer,
wherein the first electrode comprises a first substrate and a second electrode composite layer disposed on the first substrate and having a same polarity as the first electrode composite layer, and
wherein the second electrode comprises a second substrate and a third electrode composite layer disposed on the second substrate and having a polarity that is different from the polarity of the first electrode composite layer.

15. The secondary battery according to claim 1, wherein the body further comprises a flange portion surrounding an open side of the body.

16. The secondary battery according to claim 15, wherein the flange portion and the cover are joined to seal the accommodation part.

17. The secondary battery according to claim 1, wherein the body and the cover are formed of a same metallic material.

18. The secondary battery according to claim 17, wherein the metallic material comprises stainless steel.

19. A secondary battery comprising:
a body comprising an accommodation part having an accommodation space;
an electrode assembly accommodated in the accommodation space, the electrode assembly comprising a first electrode, a second electrode, and a separator disposed between the first electrode and the second electrode;
a cover disposed on the body;
a first electrode composite layer attached to a lower surface of the cover;
a second electrode composite layer attached to a bottom portion of the body;
a second separator disposed between the first electrode composite layer and the electrode assembly; and
a third separator disposed between the second electrode composite layer and the electrode assembly.

20. The secondary battery according to claim 19, wherein the first electrode composite layer and the second electrode composite layer each comprise a dry electrode composite film.
